(19) United States
(12) Patent Application Publication
(10) Pub. No.: US 2005/0079915 A1
(43) Pub. Date: Apr. 14, 2005

(54) Cam system stabilizer

(76) Inventors: Vaughn Bigelow, Lafayette, CO (US); Marvin Hoffman, Alexandria, MN (US)

Correspondence Address: RUSSELL T. MANNING;MARSH FISCHMANN & BREYFOGLE LLP, 3151 S. VAUGHN WAY #411, AURORA, CO, 80014, US

(21) Appl. No.: 10/684,612

(22) Filed: Oct. 14, 2003

(51) Int. Cl. F16D 3/08

(52) U.S. Cl. 464/50

(57) ABSTRACT

A centering mechanism for a constant velocity torque transfer device that transfers rotary power from a first shaft to a second shaft via an intermediate shaft or connecting yoke. The centering mechanism maintains the first and second shafts at equal angles relative to the intermediate shaft while permitting relative movement between the first and second shafts. More particularly, the intermediate shaft houses a cam tube which in turn houses linkage members that interconnect with the first and second shafts. Movement by one of the shafts is transferred to the other shaft via the linkage. In this regard, the centering mechanism maintains a strict geometrical relationship between the shafts that is required to produce a constant velocity joint. In one embodiment, the cam tube of the centering device is rotationally coupled to the inside surface of the intermediate shaft to support the device as well as dampen vibrations.

### FIELD OF THE INVENTION

The present invention relates to constant velocity torque transfer devices for transferring rotary motion and torque between first and second shafts via an intermediate shaft while allowing the first and second shafts to move (e.g., angularly) relative to one another. In particular, the present invention relates to a constant velocity torque transfer device that minimizes vibration in the intermediate shaft to allow for increased operating efficiency and speeds.

### BACKGROUND

Torque transfer devices generally involve two or more shafts interconnected to transfer rotary power (i.e., torque) from a power source to an output. Devices that allow for transfer of torque between two shafts disposed at an angle to one another may be referred to as angular linkages. Such angular linkages include, for example, gear boxes and universal joints. Gearboxes generally include a first gear rotationally fixed to an input shaft and a second gear rotationally fixed to an output shaft. Typically gear boxes are utilized for fixed angle torque transfer applications.

Universal joints provide the ability to accommodate varying input shaft/output shaft geometries. For example, one or more universal joints may be utilized for transferring power from a transmission to the wheels of an automobile. In this case, the universal joint(s) may allow for the transfer of power between the transmission and the wheels via one or more shafts that are not necessarily linearly aligned. In addition to transferring power between non-aligned shafts, such universal joints permit movement between two rotating shafts to accommodate for changes in the operating environment. For example, as the suspension of an automobile operates (e.g., compresses or otherwise travels), the angle between two interconnected shafts of a mechanical linkage may change.

Universal joints typically employ pins to rotationally couple structure associated with an input shaft to structure associated with an output shaft. A variety of structures including yokes, balls, intermediate shafts and the like may be employed in this regard. A common universal joint utilized to interconnect rotating members (e.g., shafts) while permitting movement therebetween is a cruciform-type universal joint. Cruciform-type universal joints typically include a pair of U-shaped members (i.e., yokes) with their midpoints attached to the ends of first and second rotating members. The open ends of the two U-shaped yokes are positioned in a facing relationship and rotated 90° relative to one another. A cruciform connecting member that includes four radially extending torque-bearing elements (i.e., trunnions) extends between the legs of each U-shaped yoke. Each radially extending torque-bearing element typically includes a coaxially aligned cap that is lined with bearings. Accordingly, when two opposing torque-bearing elements are interconnected to the legs of a U-shaped yoke, a pivotal connection is formed between the cruciform member and the U-shaped yoke.

Another universal joint assembly, the ring-type universal joint, may also be utilized to connect rotating members while permitting movement therebetween. Like cruciform-type joints, ring-type universal joints are utilized to pivotally interconnect yoke members (e.g., U-shaped) attached to the ends of first and second rotating members (e.g., shafts). However, as opposed to utilizing a connecting member that extends between the open ends of the yokes, the ring-type joint utilizes an annular connecting member that surrounds the yokes and receives torque transfer elements that extend radially outward from the yokes. Due to their annular geometry, ring-type universal joints allow for an increased range of movement between the rotational axes of two interconnected members in comparison with cruciform-type joints. Furthermore, ring-type joints experience less vibration and eliminate stress concentration problems associated with cruciform-type joints, thereby allowing for increased load transfer between interconnected rotating members.

While providing a simplified, cost-effective means to transfer power between rotating shafts, universal joints suffer from several problems. For example, two shafts interconnected by a universal joint generally do not rotate at the same speed throughout a rotation cycle when the shafts are at an angle to one another. Though each shaft completes one revolution in the same time as the other shaft, the relative speeds of the two shafts vary during rotation. In this regard, an input shaft driven by a power source may rotate at a constant velocity. However, an output shaft interconnected to the input shaft via a universal joint will, during each rotation, typically rotate faster than the input shaft in four instances, rotate slower than the input shaft in four instances, and rotate at the same velocity as the input shaft in four instances. This can create problems (e.g., vibrations) where shaft speed is high or where the load on the shafts is high. The problem is particularly pronounced where both high speed and high load conditions are present.

In order to alleviate non-constant rotation of the output shaft relative to the input shaft, an intermediate shaft may be utilized. In this regard, the input and output shafts are interconnected to the intermediate shaft via first and second universal joints. When the input and output shafts are held in a strict geometric relationship (i.e., at equal angles relative to the intermediate shaft and in a common plane), the output shaft rotates at a substantially constant angular velocity relative to the input shaft. In this regard, the intermediate shaft still rotates at a non-constant angular velocity relative to the input shaft, and the output shaft rotates at a non-constant angular velocity relative to the intermediate shaft, but these effects tend to cancel each other out such that the output shaft rotates at a substantially constant angular velocity with the input shaft.

While solving the non-constant velocity rotation problem, utilization of a double joint and an intermediate shaft requires the shafts move in a strict geometrical relationship. Furthermore, utilization of a double joint and an intermediate shaft may increase vibration in a system.

### SUMMARY OF THE INVENTION

An objective of the present invention is to provide a constant velocity torque transfer device having reduced vibration.

The present invention is directed towards a constant velocity torque transfer device for transferring rotary power from a first shaft to a second shaft. In particular, the constant velocity torque transfer device utilizes two universal joints and an intermediate shaft or “connecting yoke” to physically interconnect first and second shafts. The device includes a centering mechanism that maintains the first and second shafts at equal angles relative to the intermediate shaft while permitting relative movement therebetween. That is, the centering mechanism maintains a strict geometrical relationship between the shafts required to produce a constant velocity joint. Various aspects of the invention are directed at providing a constant velocity torque transfer device including a centering mechanism that is less susceptible to induced vibration than existing devices. In any aspect, it will be appreciated that the torque transfer device may be utilized in mechanical linkage systems where multiple torque transfer devices are utilized.

According to a first aspect of the present invention, a constant velocity torque transfer device is provided that includes a centering device rotatively coupled within a connecting yoke that transmits torque from a first shaft to a second shaft. The centering device includes a linkage that extends through the connecting yoke between the first and second shafts upon assembly of the device. The linkage includes a first member associated with the first shaft, a second member associated with the second shaft and a joint that couples the first and second members (e.g., their adjacent ends) within the connecting yoke. The joint transfers rotational movement between the first and second linkage members. A bearing assembly is rotatively coupled with an inside surface of the connecting yoke. The bearing assembly includes a bore that is offset from a rotation axis of the connecting yoke. This offset bore rotates epicyclically relative to the rotational axis of the connecting yoke. The offset bore houses the linkage joint and maintains the adjacent ends of the linkage members at a non-zero angle. Accordingly, the joint and the adjacent ends of the linkage members rotate epicyclically relative to the rotational axis of the centering yoke. This epicyclical movement combined with the non-zero angle maintained between the adjacent ends of the linkage members allows the transmission of non-rotational movement between the first and second shafts such that these shafts may be maintained at equal angles relative to the connecting yoke.

While housing the joint and maintaining the linkage members at a non-zero angle, the bearing assembly also allows these components to rotate relative to the offset bore while being maintained at the non-zero angle. In this regard, the offset bore of the bearing assembly may be elongated to support the linkage members. Furthermore, the offset bore may also include bearings and/or bushings to facilitate rotation of the linkage components.

The bearing assembly also rotatively couples the linkage components to the inside surface of the connecting yoke. In this regard, the outside perimeter of the bearing assembly may rotate about a common rotational axis with the connecting yoke while the linkage components disposed in the offset bore rotate in a fixed orbit around that common axis (i.e. epicyclically). In this regard, the joint and adjacent ends of the linkage members, while being permitted to rotate epicyclically around the rotational axis of the connecting yoke, may be maintained at a fixed distance relative to the inside surface (i.e., bore) of the connecting yoke. That is, the bearing assembly may maintain a fixed rotational relationship between the inside surface of the connecting yoke and the linkage components. During high-speed operations where the linkage components are rotating relative to the connecting yoke, this fixed rotational relationship may substantially eliminate vibration due to the epicyclic movement. To achieve this fixed rotational relationship, a substantial portion or an entire outside perimeter of the bearing assembly may be rotatably coupled to the inside surface of the connecting yoke. That is, the bearing assembly may have a circular outside surface with an off-centered bore extending therethrough. However, it will be appreciated that the outside perimeter of the bearing assembly need not be continuous. For example, this outside surface may include one or more bores or channels for lubricants.

The joint may be any mechanism that is operative to rotatively couple the first linkage member to the second linkage member. For example, the joint may mechanically attach the linkage members. In this regard, the end of each linkage member disposed within the bearing assembly may include a yoke adapted to receive a connecting member that permits non-aligned rotation between the linkage members (e.g., cruciform, cube or ring connectors). Alternatively, the joint may not be mechanically attach the linkage members. For example, upon assembly the torque transfer device may maintain the linkage members in contact with one another. In this embodiment, a slip joint may be utilized to transfer rotary motion between the linkage members. In this regard, one of the linkage members may include a slot or socket and the other linkage member may include a key sized to fit within the slot. As will be appreciated, this key and slot arrangement may allow for some relative movement (e.g., non-rotational) between the first and second linkage members during operation of the constant velocity device. However, this is not a requirement.

While the adjacent ends of each linkage member are rotatively interconnected by the joint and received within the connecting yoke, the second end of each of these linkage members is disposed within one of the first and second shafts. In this regard, the first and second shafts will necessarily include internal bores (e.g., aligned with their rotational axes) for receiving the second ends of the linkage members. Typically, such bores will be formed to receive these linkage members in a concentric relationship. Furthermore, these bores may include bearing assemblies to provide for enhanced rotation with the linkage members. These bearing assemblies may include, without limitation, ball bearings, needle bearings, elliptical bearings, sleeve bearings and/or bushing assemblies. In any case, these bearing assemblies will typically be sized such that there is substantially no lateral movement (i.e., non-rotational) between the linkage members and the shafts. In this regard, when one shaft moves (i.e., non-rotationally) the linkage member disposed therein also moves. This movement is transferred through the connecting yoke via the linkage joint to the other linkage member, which moves the other shaft in a like manner.

In order to allow the first and second shafts to move over an extended range relative to the connecting yoke and therefore, to one another, the first and second linkage members may include an angular displacement between their first and second ends. That is, the first and second linkage members may be bent. For example, each linkage member may comprise a rod having a first end disposed within the offset bore of the bearing assembly and a second end disposed within one of the shafts. In this regard, each rod may form first and second cylindrical surfaces that are rotatively coupled to the offset bore of the bearing assembly and one shaft, respectively. These connecting rods may be bent at predetermined angles between their first and second cylindrical surfaces. To insure that the first and second shafts move at equal angles relative to the connecting yoke, the first and second linkage members, when bent, may be bent at equal angles. Furthermore, to allow the first shaft, the second shaft, and the connecting yoke to rotate about a common axis, the bends in the first and second linkage members may be equal to one half of the non-zero angle maintained between their adjacent ends by the bearing assembly. In this regard, each linkage may rotate relative to the offset bore such that the angle formed between the cylindrical surfaces of each linkage cancels out the angle maintained between the linkage members. That is, the angles may be disposed at an equal and opposite manner such that the first and second shafts may be disposed along a common rotational axis.

Alternatively, the angles defined by the first and second linkage members and the non-zero angle maintained between the linkage members may be combined to allow the first and second shafts to be disposed at a non-zero angle. In particular, where the linkages are bent at equal angles (e.g., β) and their adjacent ends are maintained at twice that angle (e.g. 2β), the first and second shafts may be disposed at four times this angle relative to one another (e.g., 4β). For example, if the first and second linkages are bent at a 10° angle and their adjacent ends are maintained at a 20° angle relative to one another, the first and second shafts may be disposed at a 40° angle relative to one another (i.e., 20° each relative to the connecting yoke). However, it will be appreciated that other angles are possible and are within the scope of the present invention. Furthermore, in this embodiment it will be appreciated that the first and second shafts may be disposed at any angle between 0 and 4β.

According to a second aspect of the present invention, a constant velocity torque transfer device is provided that utilizes a centering tube disposed within a connecting yoke to allow first and second yokes, which may be attached (e.g., welded) to first and second shafts, to move at equal angles relative to the connecting yoke. A first connecting rod is rotatably received within a first end of the tube and a second connecting rod is rotatably received within a second end of the tube. A joint disposed within the centering tube rotatively couples the first and second connecting rods. That is, the centering tube receives an end of first and second connecting rods and houses a joint that interconnects those rods. A second end of each connecting rod is received within one of the first and second yokes such that movement of one yoke may be transferred, via the linkage through the connecting yoke, to the other yoke. At least a portion of an outside perimeter of the centering tube is rotatably coupled to an inside surface of the connecting yoke. The centering tube and the linkage formed by the first and second connecting rods and joint collectively form a centering device that permits the first and second yokes, and hence connected shafts, to move at like angles relative to the connecting yoke.

In one embodiment, the centering tube is bent at a non-zero angle. In this regard, the tube may be bent at its center such that the each end of the tube forms an equally sized socket for receiving the connecting rods. These sockets will typically be disposed at equal angles relative to a rotational axis of the connecting yoke. When the connecting rods are inserted into these sockets, they are each held at a non-zero angle relative to the rotational axis of the connecting yoke and twice the non-zero angle relative to one another. In this embodiment, the joint must allow the connecting rods to rotate about non-aligned axes. In any case, the centering tube and the connecting rods are rotatively coupled. In this regard, the centering tube may include bearings such that the connecting rods may freely rotate therein.

To allow the centering tube to be bent while being rotatively coupled to the inside surface of the connecting yoke, the centering tube may include a lobe sized for engaging the inside surface of the connecting yoke. That is, the centering tube may comprise a bent tube and a circular lobe. This lobe may be formed in the middle of the tube (i.e., at the bend angle). Furthermore, the tube may pass through the circular lobe at a point offset from the lobe's center. In this regard, an outside perimeter of the circular lobe may engage a circular bearing on the inside surface of the connecting yoke (i.e., within a central bore of the connecting yoke) such that the circular lobe and the connecting yoke rotate about a common rotational axis. However, the centering tube may be offset from this rotational axis. In this regard, the centering tube may hold the connecting rods offset relative to the rotational axis of the connecting yoke.

The rotational coupling of the centering tube and/or the lobe with the inside surface of the connecting yoke supports the middle of the linkage, thereby stiffening the linkage. That is, if the centering tube were not rotationally coupled to the inside surface of the connecting yoke, the first and second connecting rods would be supported by their interfaces with first shaft and the second yokes while being held together by the centering tube. In this regard, the unsupported length of the linkage would be twice the unsupported length of a linkage utilizing a rotationally coupled centering tube. As will be appreciated, during operation of the constant velocity torque transfer device there may be flexure in the linkage. The longer the linkage, the greater the flexure. Accordingly, this flexure may result in undesirable vibration. By rotationally coupling the centering tube to the inside surface of the connecting yoke, the center of the linkage is supported and its effective length is halved. Accordingly, the linkage is stiffened and flexure is reduced. This stiffening may result in reduced vibration along the length of the linkage, thereby resulting in a smoother constant velocity torque transfer device.

As noted, the second end of each connecting rod is receivable within one of first and second yokes that may be attached to first and second shafts. Accordingly, the first and second yokes will typically include central bores for receiving the connecting rods, which may be bent at a non-zero angle between their first and second ends in a like manner as discussed above to allow a range of movement between the yokes. Universal joints may be utilized to connect the first and second yokes to the connecting yoke.

According to a third aspect of the present invention, a centering device for a constant velocity torque transfer device is provided. The centering device includes a tube that is bent at an angle between its first and second ends. A lobe is disposed on an outside surface of the tube (e.g., at the bend angle) that is sized for receipt within a central bore of the connecting yoke of a constant velocity torque transfer device. The lobe rotatively couples the bent tube to the inside surface of the connecting yoke. First and second linkage members are received within the ends of the bent tube. These linkage members are interconnected by a joint within the tube. This joint transfers motion (e.g., rotary) between the linkage members, which are able to rotate relative to the bent tube. Each linkage member has a second end adapted for receipt within one of a first shaft and a second shaft that is interconnectable to the connecting yoke.

Upon assembly of the connecting yoke and shafts, the linkage members, and the tube form a centering device that allows the first and second shafts to be maintained at equal angles relative to the centering yoke. In this regard, the linkage members may be bent between their first and second ends to permit the first and second shafts to move over a predetermined angular range relative to the connecting yoke. In any case, the lobe on the outside surface of the tube, which may be integrally formed therewith, prevents vibration between the centering device and the connecting yoke. This allows such constant velocity torque transfer devices to operate more smoothly and/or at higher speeds.

### BRIEF DESCRIPTION OF THE DRAWINGS

FIG. 1 shows a perspective view of a constant velocity first torque transfer device;

FIG. 2 shows an exploded view of the device of FIG. 1;

FIG. 3 shows a side view of a centering device that may be incorporated into the constant velocity torque transfer device of FIG. 1;

FIG. 4 shows the centering device of FIG. 3 in a different angular arrangement;

FIG. 5 shows a connecting tube of the device of FIG. 3;

FIG. 6 shows first and second linkage members of the device of FIG. 3;

FIG. 7 shows the connecting tube of FIG. 3 superimposed on the linkage members of FIG. 3;

FIG. 8 shows a perspective view of the connecting tube of FIG. 5;

FIG. 9 shows the centering device of FIG. 3 and a connecting yoke that may be utilized with the constant velocity torque transfer device of FIG. 1.

### DETAILED DESCRIPTION

The present invention is directed to a constant velocity torque transfer device utilized to transfer rotary power from a first rotating shaft to a second rotating shaft. The invention is applicable to a variety of applications including at least one set of rotating elements that may not be directly aligned, or, that may change alignment during operation. The invention is particularly apt for use in automotive applications. It will be appreciated, however, that the invention is not limited to such applications.

In the following description, the embodiments of angular linkage devices provided are constant velocity devices that utilize an input and output shaft interconnected by an intermediate shaft (also referred to as a connecting yoke). The input and output shafts are interconnected to the intermediate shaft by two universal joints. As shown in the embodiments herein, the universal joints utilized to interconnect the various shafts are ring-type universal joints. The function of such ring-type universal joints is more fully discussed in co-pending U.S. patent applications Ser. No. 10/396,736 entitled: “RIGID BENT BAR SELF-SUPPORTING CV JOINT,” filed on Mar. 25, 2003; No. 10/396,737 entitled “UNIVERSAL JOINT YOKE ADAPTER,” filed on Mar. 25, 2005; and No. 10/396,739 entitled “UNIVERSAL JOINT ADAPTER RING,” filed on Mar. 25, 2003, the contents of which are incorporated by reference herein as if set forth herein in full.

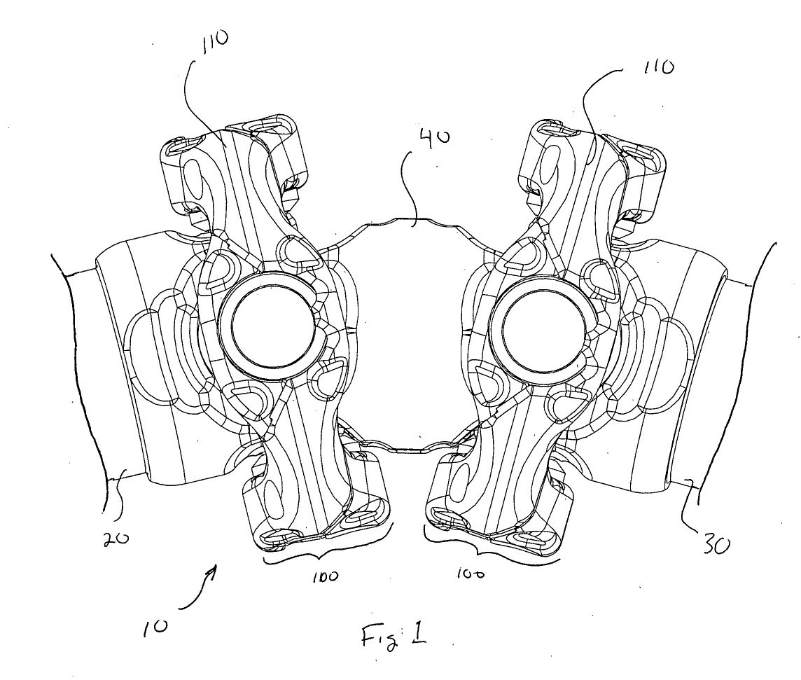

As shown in FIG. 1, the torque transfer device 10 comprises a first drive shaft 20 interconnected to a second drive shaft 30, via an intermediate shaft 40 using two ring-type universal joints 100. More particularly, the first drive shaft 20 is interconnected to a first end of the intermediate shaft 40 by a first ring-type universal joint 100 and a second drive shaft 30 is interconnected to an opposing end of the intermediate shaft 40 by a second ring-type universal joint 100. The ring-type universal joints 100 pivotally connect each shaft 20, 30 to the intermediate shaft 40 about two pivot axes. That is, each shaft 20, 30 has two rotational degrees of freedom relative to the intermediate shaft 40. When held in a strict geometrical relationship, where the first and second shafts 20, 30 are disposed at like angles relative to the intermediate shaft 40 and the rotational axes of each shaft 20, 30, 40 are coplanar, a constant velocity torque transfer device 10 is formed. To maintain this strict geometrical relationship, a centering mechanism is utilized, as will be discussed herein.

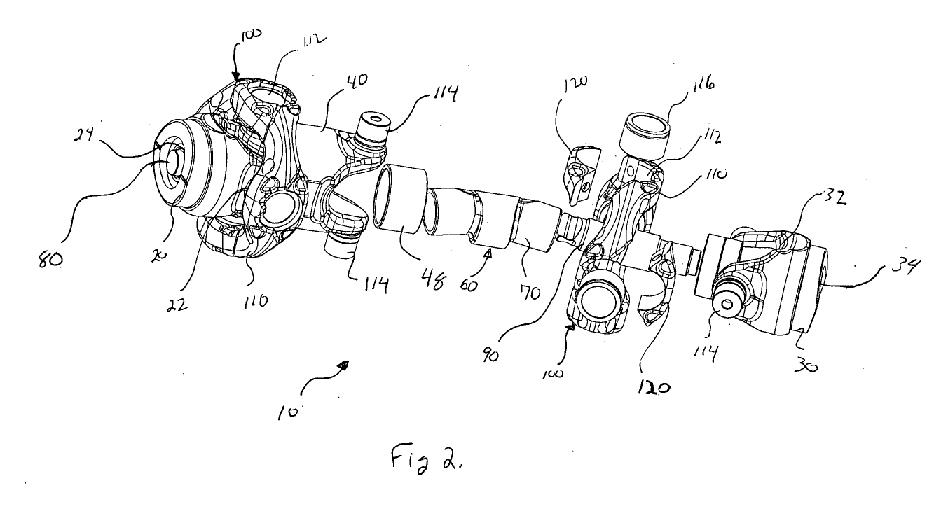

FIG. 2 shows an exploded perspective view of the constant velocity torque transfer device 10. As shown, each ring-type universal joint 100 utilizes an external ring 110 to transfer rotary torque between the intermediate shaft 40 and one of the first and second shafts 20, 30. In this regard, each end of the first and second shafts 20, 30 include a U-shaped yoke 22, 32, respectively. Likewise each end of the intermediate shaft 40 includes a U-shaped yoke 42, 44 (see for example FIG. 9). The open ends of the yokes 22, 42 and 32, 44 are in a facing relationship and rotated 90° relative to one another. The external rings 110 surround the yokes 22, 42 and 32, 44 and receive torque-transfer elements (trunnions 114) extending radially outward there from. Accordingly, each external ring 110 includes four radial bores 112, equally spaced about their circumference for receiving the trunnions 114. In the embodiment shown, removable retainers 120 are attached to the external rings 110 to define each of the four radial bores 112. These retainers 120 may be interconnected to the rings 110 utilizing two bolts (e.g., one on either side of the radial bore 112). However, it will be appreciated that the radial bores 112 may be formed entirely within a solid ring 110.

The trunnions 114 may be integrally formed with the yokes 22, 32, 42 and 44 or may be otherwise attached thereto. In this latter regard, the trunnions 114 may be formed as separate pins received by both the yokes 22, 32, 42 and 44 and the rings 110. For example the trunnions 114 may threaded into the yokes 22, 32, 42 and 44 and received within the radial bores 112 of the external rings 110. Furthermore, each trunnion 114 will typically include a bearing cap assembly 116 allowing each opposing pair of trunnions 114 to create a pivotable connection between the ring 110 and the respective yoke 22, 32, 42 and 44.

For each ring-type joint 100, a first pair of opposing radial bores 12 define a first pivot axis with the intermediate shaft 40, while a second pair of the bores 12 defines a second pivot axis with one of the shafts 20, 30. As will be appreciated, once the intermediate shaft 40 and the first and second shafts 20, 30 are interconnected via the external rings 110, these components 20, 30 and 40 have two rotational degrees of freedom relative to one another, thereby allowing the two interconnected members to rotate about non-aligned axes of rotation. Furthermore, due to the geometry of the external rings 110, these components have a greater allowable range of motion as compared to such components interconnected with a cruciform type joint.

As noted, the torque transfer device 10 also includes a centering mechanism 60 for maintaining the strict geometrical relationship between the first and second shafts 20, 30 required for constant velocity operation. As shown in FIGS. 2-4, the centering mechanism 60 contains a cam tube 70 that is rotatably received within an internal bore 46 of the intermediate shaft 40, a first connecting rod 80 extending between one end of the cam tube 70 and an internal bore 24 of the first shaft 20, and a second connecting rod 90 extending between the other end of the cam tube 70 and an internal bore 34 of the second drive shaft 30.

Each bore 24, 34, and 46 includes a bearing assembly 26, 36 and 48 to allow the respective shafts 20, 30, and 40 to more easily rotate relative to the section of the centering mechanism 60 disposed therein. That is, bearing assemblies 26, 36 and 48 may be disposed between the inside surface of the bores 24, 34 and 46 and the outside surfaces of the respective sections 60, 70 and 90 of the centering mechanism 60. The term bearing assemblies includes, without limitation, needle bearings, ball bearings, sleeve bearings, as well as bushing assemblies.

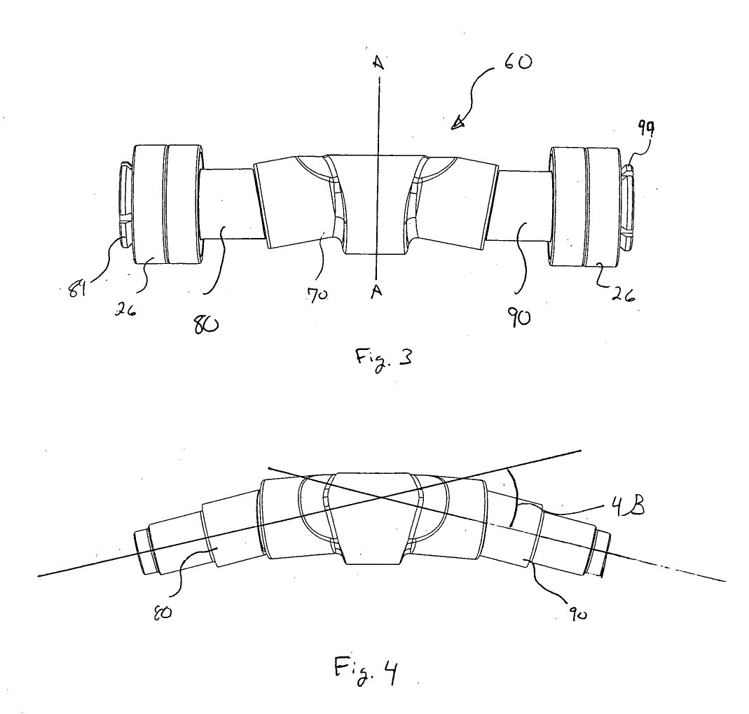

FIG. 3 shows the centering mechanism 60 removed from the torque transfer device 10 wherein the first and second connecting rods 80, 90 are inserted within the cam tube 70. Furthermore, bearings 26, 36 which may be disposed within the first and second shafts 20, 30 upon assembly as well as retaining nuts 89, 99 are shown disposed on the ends of the first and second connecting rods 80, 90 for illustrative purposes. The retaining nuts 89, 99 are utilized to maintain the connecting rods 80, 90 within their respective shafts 20, 30 upon assembly. The purpose of the centering mechanism 60 is to provide a mechanical means to connect first and second shafts 20, 30 of a double joint torque transfer device 10 in a manner that forces each shaft 20, 30 to operate at the same angle with respect to the intermediate shaft 40. The centering mechanism 60 provides internal support to maintain facing ends of the connecting rods 80, 90 in a fixed relationship such that the torque transfer device 10 is self-supporting and self-aligning. In this regard, the connecting rods 80, 90 form a linkage that physically interconnects the first and second shafts 20, 30.

The connecting rods 80, 90 are able to rotate relative to the cam tube 70 and the cam tube 70 is able to rotate within the bore of the intermediate shaft 40. The relative rotational movement between the centering mechanism components, in conjunction with these components being formed at offsetting angles relative to a centerline of the centering mechanism 60, allows the first and second shafts 20, 30 to be aligned, or, disposed at an angle relative to one another. That is, each connecting rod 80, 90 as well as the cam tube 70 are bent at predetermined angles to allow angular movement of the first and second shafts 20, 30 relative to the intermediate shaft 40. Furthermore, the connecting rods 80, 90 are rotatably coupled such that if one connecting rod 80, 90 is turned (i.e. by one of the shafts 20, 30) the other connecting rod 80, 90 turns in a like manner (i.e. which may also turn the other shafts 20, 30). In this regard, the first and second shafts 20, 30 are maintained at equal angles relative to the intermediate shaft 40.

Referring to FIGS. 3-9, the operation of the centering mechanism 60 is more fully described. As shown in FIGS. 5 and 8, the cam tube 70 includes first and second sockets 72a, 72b sized to receive an end of each of the first and second connecting rods 80, 90. The sockets 72 are each disposed at an angle β relative to a centerline axis of the intermediate shaft 40 when the cam tube 70 is disposed therein. In this regard, the cam tube 70 rotatably supports the first and second connecting rods 80, 90 at equal angles β relative to the intermediate shaft 40 and at twice that angle 2β to relative one another.

Referring to FIG. 6, it will be noted that each connecting rod 80, 90 has first and second straight sections 82, 84 and 92, 94, which are each disposed at an angle β relative to one another. Furthermore, each rod 80, 90 includes two cylindrical bearing surfaces 86, 88 and 96, 98 corresponding with each straight section 82, 84 and 92, 94. One bearing surface 86, 96 of each connecting rod 80, 90 is received within a bearing assembly 74 that is press fit within the corresponding sockets 72 of the cam tube 70 (see for example FIGS. 7 and 8). The opposite bearing surface 88, 98 of each connecting rod 80, 90 is received within a bearing assembly 26, 36 disposed within the first and second shafts 20, 30. See for example FIG. 3.

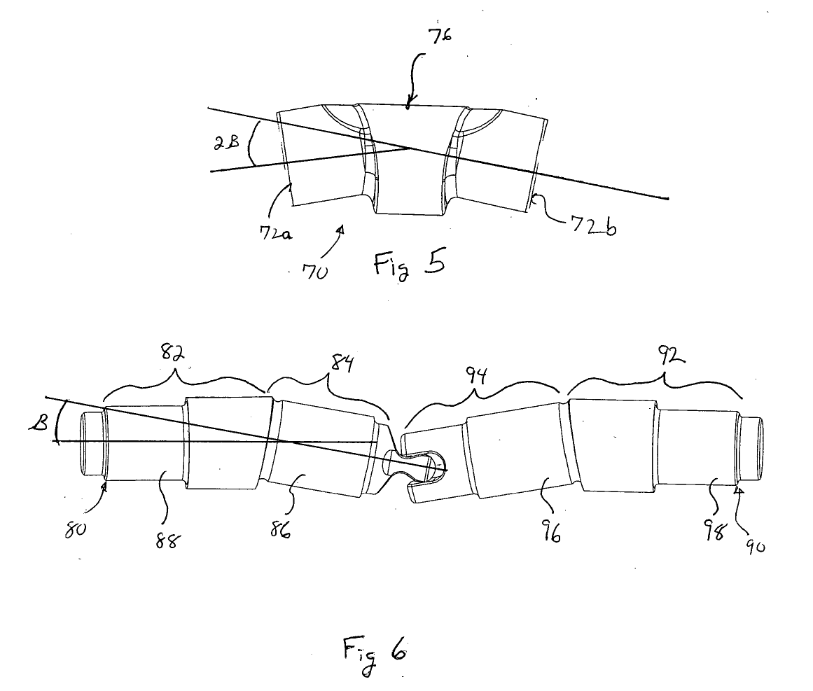

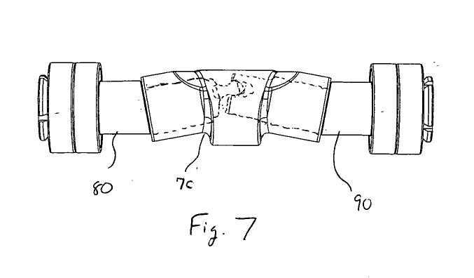

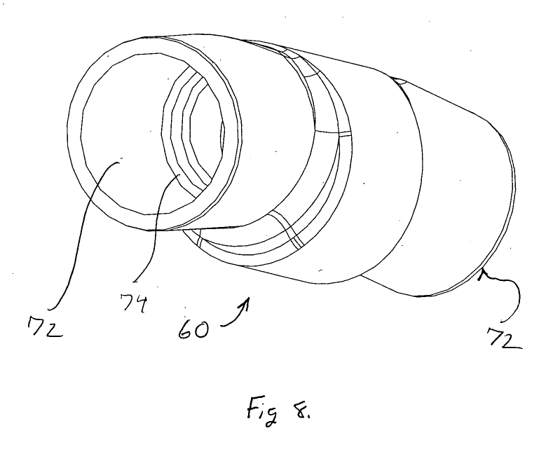

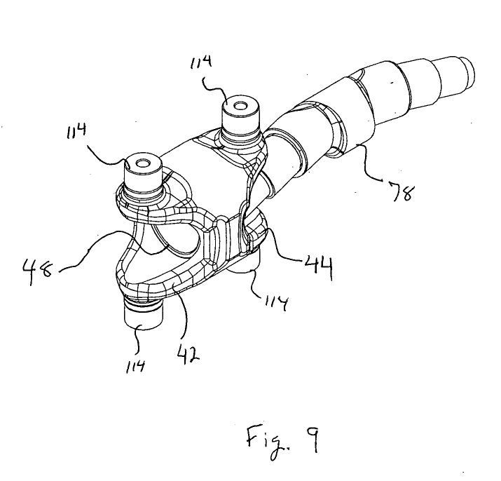

Of note, the angle β between each sockets 72a, 72b of the cam tube 70 and the rotational axis of the intermediate shaft 40 and the angles β formed by the straight sections 82, 84 and 92, 94 of the connecting rods 80, 90 are equal. In this regard, when the centering mechanism 60 is assembled the connecting rods 80, 90 can rotate to a position such that the second bearing surfaces 88, 98 are disposed at a 0° angle relative to one another (see FIG. 3). That is, each connecting rod 80, 90 may be rotated relative to reference line A-A (see FIG. 3) such that the various angles cancel out allowing the first and second shafts 20, 30 to be aligned. Alternatively, the centering mechanism components 70, 80 and 90 can rotate such that the angles are additive. In this regard, the first and second shafts 20, 30 may be misaligned with respect to one another at an angle up to four times the angle β. See FIG. 4. Furthermore, the centering mechanism components 70, 80 and 90 may be aligned such that the first and second shafts may be disposed at any angle between 0° and 4β. In the embodiment shown, β corresponds to a 10° angle such that the first and second shafts 20, 30 may be disposed relative to one another in a range of 40°. However, it will be appreciated that the invention is not limited to this angular operating range and other angular ranges are possible and within the scope of the present invention.

In order to move the first and second shafts 20, 30 at equal angles relative to the intermediate shaft 40, the first and second connecting rods 80, 90 of the centering mechanism 60 are rotatably coupled. In particular, as shown in FIG. 6, the first connecting rod 80 includes a key 130 and the second connecting rod 90 includes a matching socket 132. The key and socket 130, 132 are sized such that there is a space between the end of the key 132 and the bottom of the socket 132. Accordingly, this allows for slight axial movement between respective connecting rods 80, 90 during operation of the torque transfer device 10.

The rigidity of the cam tube 70 supports the connecting rods 80, 90 such that the first and second shafts move at equal angles relative to the intermediate shaft 40. However, if the cam tube 70 of the centering mechanism 60 is not supported within the intermediate shaft, the connecting rods 80, 90 (i.e., which extend into the first and second shafts 20, 30) may flex along their length during operation. This can introduce vibration into the device 10.

Another source of vibration for the device is the epicyclic movement of the centering device 60 components 70, 80 and 90. In operation, the facing ends of the first and second connecting rods 80, 90 (i.e., the projection 130 and socket 132) are not aligned with the centerline axis of the intermediate shaft 40. That is, they rotate epicyclically relative to the inside surface (i.e. bore) of the intermediate shaft 40. Likewise, the cam tube 70 would also rotate epicyclically relative to the inside surface of the intermediate shaft. During operation, the epicyclic movement (i.e., unbalanced) of the components 70, 80 and 90 relative to the circular bore of the intermediate shaft 40 can also result in an induced vibration in the torque transfer device 10. This is particularly evident at elevated speeds wherein harmonically induced vibrations may occur. To prevent this vibration, the central section of the cam tube 70 includes a circular lobe 78.

The circular lobe 78 rotationally couples the centering device 70 to the intermediate shaft 40. The lobe 78 is offset from the epicyclic bore of the cam tube 70 (i.e., where the sockets 72 intersect at the center of the cam tube 70). In this regard, the connecting rods 80, 90 may continue to rotate in an epicyclic manner. However, the offset circular lobe 78 allows the cam tube 70 and connecting rods 80, 90 to remain at a constant rotational distance from the inside surface of the intermediate shaft 40. The circular lobe 78 is received within a like-sized bearing 48 that may is press fit within the intermediate shaft 40 as shown in FIG. 9. The circular lobe 78 rotatably couples the centering mechanism 60 with the inside surface of the intermediate shaft 40, thereby supporting the centering mechanism 60 at its center to increase the mechanism's overall rigidity and thus inhibit vibration. Additionally, the vibrations induced through epicylic movement are reduced. That is, the offset lobe 78 results in a more balanced centering mechanism 60. Finally, the constant coupling between the centering mechanism 60 and the intermediate shaft 40 dampens any induced vibrations. Use of the offset circular lobe 79 allows the first and second connecting rods 80, 90 to move epicyclically relative to the intermediate shaft 40 as required to produce a self-supporting, self-aligning centering mechanism 60 while eliminating vibrations typically caused by the epicyclic movement of an unsupported centering mechanism within the intermediate shaft 40.

The foregoing description of the present invention has been presented for purposes of illustration and description. Furthermore, the description is not intended to limit the invention to the form disclosed herein. Consequently, variations and modifications commensurate with the above teachings and skill and knowledge of the relevant art are within the scope of the present invention. The embodiments described hereinabove are further intended to explain best modes known of practicing the invention and to enable others skilled in the art to utilize the invention in such, or other, embodiments and with various modifications required by the particular application(s) or use(s) of the present invention. It is intended that the appended claims be construed to include alternative embodiments to the extent permitted by the prior art.

1. A constant velocity torque transfer device, comprising:
a first shaft;
a second shaft;
a connecting yoke for transmitting torque from said first shaft to said second shaft;
a linkage extending within said yoke between said first and second shafts, said linkage including a first member associated with said first shaft and a second member associated with said second shaft and a joint coupling said first and second members; and
a bearing assembly rotatively coupled with an inside surface of said connecting yoke, said bearing assembly having a bore offset from a rotational axis of said connecting yoke, wherein said bore houses said joint and maintains said members at a non-zero angle.

2. The device of claim 1, wherein said linkage and said bearing assembly collectively define a centering means allowing said first and second shafts to move at equal angles relative to said connecting yoke.

3. The device of claim 1, wherein an outside perimeter of said bearing assembly rotates about said rotational axis of said connecting yoke.

4. The device of claim 1, wherein an entire outside perimeter of said bearing assembly is rotatively coupled with said inside surface of said connecting yoke.

5. The device of claim 1, wherein said joint transfers rotational movement between said first and second members of said linkage.

6. The device of claim 5, wherein said first and second members are operative to rotate within said bore while being maintained at said non-zero angle.

7. The device of claim 1, wherein each said member includes a first end section disposed in said bore of said bearing assembly and a second end section rotatively coupled to one of said first and second shafts.

8. The device of claim 7, wherein said second end section of each said member is aligned with a rotational axis of said one of said first and second shafts.

9. The device of claim 8, wherein said first and second end sections comprise first and second cylindrical surfaces, respectively.

10. The device of claim 9, wherein first and second longitudinal axes defined by said first and second cylindrical surfaces intersect and are disposed at a second non-zero angle.

11. The device of claim 1, wherein each of said members are bent at a second non-zero angle along their length.

12. The device of claim 11, wherein said second non-zero angle of said first and second members of said linkage are equal to one-half of said non-zero angle maintained between said first and second members.

13. The device of claim 1, wherein said bearing assembly further comprises:
a tube bent at said non-zero angle, wherein said tube passes through said bore of said bearing assembly.

14. The device of claim 13, wherein first and second ends of said tube form first and second sockets for receiving end sections of said first and second member.

15. The device of claim 1, wherein said connector includes a first end physically interconnected to said first shaft via a first joint and a second end physically interconnected to said second shaft via a second joint.

16. The device of claim 15, wherein said joint is a ring-type universal joint.

17. The device of claim 1, wherein said first and second shafts each has an internal bore sized to receive a corresponding portion one of said first and second members of said linkage.

18. The device of claim 17, wherein each internal bore further comprises:
bearings disposed about a perimeter of said bore.

19. The device of claim 17, further comprising:
retainers for retaining said portion of each said member within said internal bore.

20. A constant velocity torque transfer device, comprising:
a first yoke attachable to a first shaft;
a second yoke attachable to a second shaft;
a connecting yoke for transmitting torque from said first yoke to said second yoke;
a linkage extending within said connecting yoke between said first and second yokes, said linkage including a first section associated with said first yoke and a second section associated with said second yoke and a joint coupling adjacent of said first section and said second section at a first non-zero angle; and
a centering tube for housing said joint, wherein at least a portion of an outside perimeter of said centering tube is rotatively coupled to an inside surface of said connecting yoke and wherein said centering tube and said linkage allow said first and second yokes to move at equal angles relative to said connecting yoke.

21. The device of claim 20, wherein an entire outside perimeter of said centering tube is rotatively coupled with said inside surface of said connecting yoke.

22. The device of claim 20, wherein said centering tube is bent at a first non-zero angle.

23. The device of claim 22, wherein said first and second sections of said linkage comprise first and second connecting rods extending between said centering tube and said first and second shafts, respectively.

24. The device of claim 23, wherein a first end each of said first and second connecting rods is rotatively received within one end of said centering tube.

25. The device of claim 24, wherein a second end of each of said first and second connecting rods is rotatively received within a bore of said first and second shafts, respectively.

26. The device of claim 24, wherein each said connecting rod is bent at a second non-zero angle between said first and second ends.

27. The device of claim 26, wherein said second non-zero angle is equal one-half of said first non-zero angle.

28. The device of claim 27, wherein said first non-zero angle is between about 1° and about 20°.

29. The device of claim 20, wherein said centering tube further comprises:
a lobe sized for receipt within a central bore of said connecting yoke.

30. The device of claim 29, wherein said tube passes through said lobe.

31. The device of claim 29, wherein said lobe is circular.

32. The device of claim 30, wherein said tube passes through said circular lobe at a point offset from the center of said circular lobe.

33. A constant velocity torque transfer device, comprising:
a first shaft;
a second shaft:
a connecting yoke rotatively connecting said first and second shafts;
a tube bent at an angle between first and second ends;
a lobe disposed on an outside surface of said bent tube and sized for receipt within a central bore of said connecting yoke, wherein said lobe rotatively couples said tube with an inside surface of said connecting yoke;
first and second linkage members, wherein each said linkage member comprises a first end rotatively received within an end of said bent tube and a second end adapted for receipt within one of said first and second shafts; and
a joint connecting said first and second linkage members within said bent tube.

34. The device of claim 33, wherein said bent tube and said lobe are integrally formed.

35. The device of claim 33, wherein said lobe is circular and wherein an outside perimeter of said circular lobe is adapted for receipt within a bearing.

36. The device of claim 35, wherein said tube passed through said circular lobe at a point offset from a rotational axis of said circular lobe.

37. The device of claim 33, wherein said bent tube maintains said first ends of said members at a non-zero angle relative to one another.

38. The device of claim 33, wherein said joint is operative to transmit rotary motion between said first and second members.

39. The device of claim 33, wherein said first and second linkage members are each bent at an angle between their first and second ends.

40. The device of claim 39, wherein said first and second linkage members are bent at an angle one-half the angle of said tube.

41-42. (canceled)
